(19) United States
(12) Patent Application Publication
(10) Pub. No.: US 2022/0096204 A1
(43) Pub. Date: Mar. 31, 2022

(54) Pinch Proxi Mark

(71) Applicant: Sabrina E. Mickel, Beachwood, OH (US)

(72) Inventor: Sabrina E. Mickel, Beachwood, OH (US)

(21) Appl. No.: 17/468,156

(22) Filed: Sep. 7, 2021

Related U.S. Application Data
(63) Continuation-in-part of application No. 29/758,281, filed on Nov. 13, 2020.
(60) Provisional application No. 63/083,569, filed on Sep. 25, 2020.

(51) Int. Cl. A61C 5/30

(52) U.S. Cl. CPC A61C 5/30

(57) ABSTRACT

A crown handling device is provided to allow an operator to hold the crown between fingers. The crown handling device comprises a matrix member; and a pinch holding member having a substantially round shape and a plurality of openings for inserting therethrough the matrix member secured to one side of the pinch holding member.

The current application claims a priority to the U.S. provisional patent application Ser. No. 63/083,569 filed on Sep. 25, 2020.

### FIELD OF THE INVENTION

The present invention generally relates to a dental device. More specifically, the present invention relates to a dental device designed to handle dental crowns.

### BACKGROUND OF THE INVENTION

A dental device that can assist in handling crowns in the mouth is in demand. A crown is a cover or “cap” that can be put over a tooth. People use crowns to restore the tooth to its normal shape, size, and function. They are typically bonded to the tooth by dental cement.

Crowns may be needed when a large cavity threatens the health of a tooth. They can be used in implant cases to replace missing teeth that have been lost due to disease, decay or an accident.

Once the crown is manufactured, it will be checked for fit and adjusted if necessary, before being permanently cemented onto your natural tooth. A dentist can design a crown to be secured on the remaining dentin or on an implant, and restore the function of that tooth so it is critically important that the crown can accurately fit the oral environment, particularly, to fit the spatial configuration of the gum area around the tooth, for the purpose of, in addition to an aesthetic appearance, the hygiene in the interfacial region between the gum, the crown and the dentin or abutment/implant.

With the advancement of technology, the restorations produced may even match the natural tooth color and blend in seamlessly. However, there are problems.

The liquid products developed to mark the interproximal margins of crowns tend to be messy and difficult to use in the wet environment of a patient's mouth. The paper marking strips that are meant to be placed between the tooth and the crown as the operator attempts to seat the crown on to the tooth to mark the margin not efficient. They are not convenient to use and not rigid enough to move back and forth easily as the operator is performing the adjustments. Thus, there is a need to develop a device to solve the problems.

The present invention is intended to address problems associated with and/or otherwise improve on conventional devices through an innovative crown handling device that is designed to provide a convenient and efficient means to mark and adjust crowns prior to cementation while incorporating other problem-solving features.

### SUMMARY

The present invention relates to a crown handling device that is provided to allow an operator to hold the crown between fingers. In one general aspect, the invention comprises a matrix member; and a pinch holding member having a substantially round shape and a plurality of openings for inserting therethrough the matrix member secured to one side of the pinch holding member.

The pinch holding member may include a substantially round ring shape so that the operator can squeeze the pinch holding member between the thumb and index finger to slightly bend the sides of the pinch holding member. The matrix member can include a band or an elongated flexible strip with each end attached to the pinch holding member to form a loop so that the crown can be held inside the loop. The matrix member may further include a marking member to make the adjustment of the dental crowns easier and faster and allow safer, more secure handling of crowns in the mouth of patients.

### BRIEF DESCRIPTION OF THE DRAWINGS

FIG. 1 is an illustration of one embodiment of the present invention.

FIG. 2 is a top view of one embodiment of the present invention.

FIG. 3 is an illustration of one embodiment of the present invention showing an elongated thin strap and the pinch holding member.

FIG. 4 is a top view of one embodiment of the present invention held by fingers.

FIG. 5 is a side view of one embodiment of the present invention.

### DETAIL DESCRIPTIONS OF THE INVENTION

All illustrations of the drawings are for the purpose of describing selected versions of the present invention and are not intended to limit the scope of the present invention.

The present invention (“pinch proxy-mark”) provides the portability of a crown (a cap for a damaged tooth) to the mouth with the marking media firmly attached to the margins of the crown and the crown firmly pinched between the fingers of an operator.

The present invention provides an innovative purpose for an existing dental product to help simplify the labor-intensive process of adjusting a dental crown to be delivered to the patient's mouth.

By allowing to hold the crown between fingers of the operator while moving the small restoration to and from the wet mouth of the patients, the present invention provides a safe method of handling the crowns.

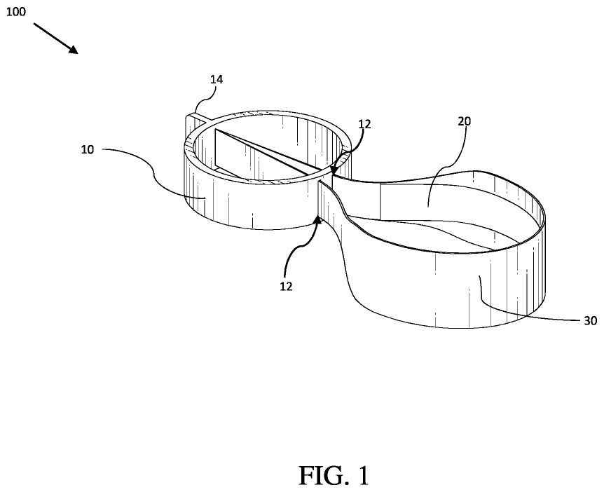

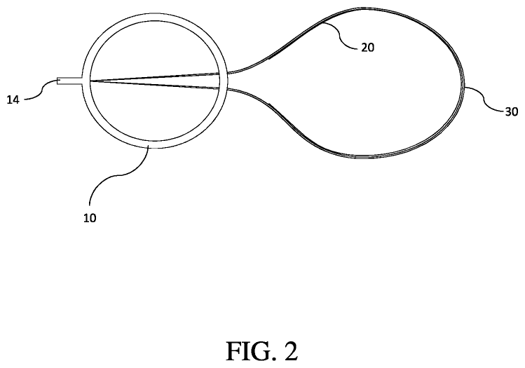

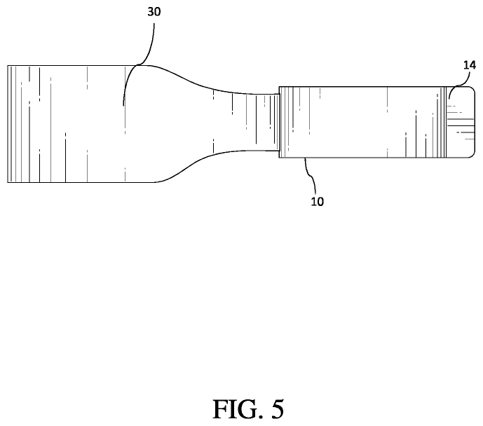

As shown in FIGS. 1 to 5, the present invention provides a crown handling device 100 comprising a pinch holding member 10 and a matrix member 30.

The pinch holding member 10 may be connected to the matrix member 30 in a way to facilitate a convenient handling of a crown.

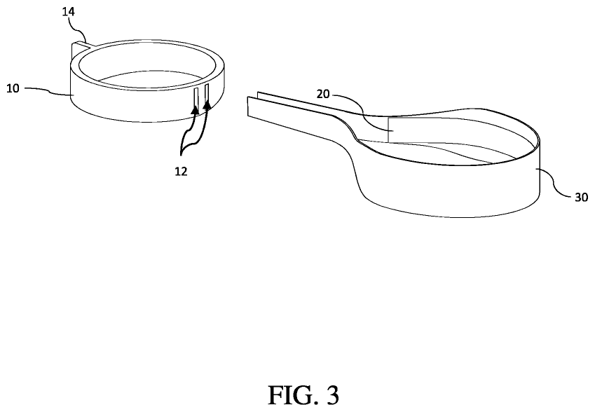

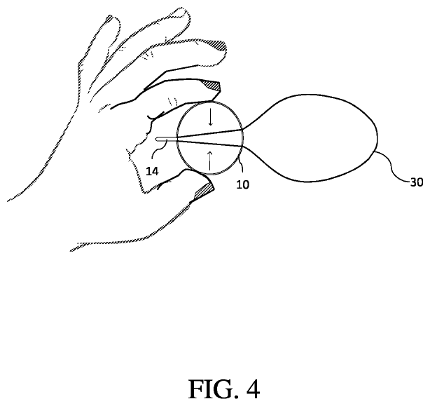

The pinch holding member 10 can include a structure designed to be conveniently held by fingers, as shown in FIG. 4, and aid in putting of the matrix member 30 around the crown. In some embodiments, the pinch holding member 10 can include a handle 14, as shown in FIG. 3, attached on the outer surface of the pinch holding member 10.

The pinch holding member 10 can be of a suitable shape and size and made of any material suitable to provide sufficient strength when the crown handling device 100 is pulled by fingers. Such suitable materials may include an aluminum or similar material that is thin, very easy to crush but rigid enough to support the strength needed.

In one embodiment, the pinch holding member 10 may include a substantially round ring shape so that the operator can squeeze the pinch holding member 10 between the thumb and index finger to slightly bend the sides of the pinch holding member 10.

In some embodiments, the pinch holding member 10 may include a fastening mechanism for attaching the matrix member 30 in a way that each ends of the matrix member 30 (e.g., an elongated thin strap) can be inserted into the pinch holding member 10 through one or more openings 12 which may be positioned on one side of the pinch holding member 10 and secured at the side opposite to the side of the pinch holding member 10 where the matrix member is inserted.

The matrix member 30 can be configured or structured to encircle the crown. The matrix member 30 can be an elongated resilient and flexible thin strip that is substantially rectangular in shape.

The matrix member 30 can be of any suitable shape and made of any material suitable for marking the interproximal margins of crowns such as plastics or similar material with sufficient flexibility.

The matrix member 30 can be fabricated from any of various well-known materials, including plastics, such as Mylar® polyester film, Nylon® or other suitable and similar resilient and flexible plastics.

In one embodiment, the matrix member 30 can include a band or an elongated flexible strip with each end attached to the pinch holding member 10 to form a loop so that the crown can be held inside the loop.

The matrix member 30 may include a marking member 20, as shown in FIGS. 1 to 3, which can be of any suitable shape and size so that the marking member 20 can be affixed (e.g., by using adhesives such as glue) on the inner side of the matrix member 30. The marking member 20 can be made of any material such as an oiled paper, a carbon paper or any other paper that can provide a means for marking the interproximal margins of crowns. This marking member may allow the operator to make a mark without a pen. The mark can be made by the corresponding pressure transferred to the crown from the adjacent tooth. In preferred embodiments, the marking member is made with a material having an ink on the inside.

This matrix member 30 may make the adjustment of the dental crowns easier and faster and allow safer, more secure handling of crowns in the mouth of patients.

In use, the operator may simply install the crown handling device 100 of the present invention on a crown and hold the crown handling device 100 by fingers and mark the interproximal margins of crowns on the marking member 20 by an appropriate tool such as a sharp pointed instrument.

Although the invention has been explained in relation to its preferred embodiment, it is to be understood that many other possible modifications and variations can be made without departing from the spirit and scope of the invention.

What is claimed is:

1. A crown handling device comprising:
a matrix member; and
a pinch holding member having a substantially round shape and a plurality of openings for inserting therethrough the matrix member secured to one side of the pinch holding member.

2. The crown handling device as claimed in claim 1, wherein the pinch holding member is a ring having two openings positioned on one side of the pinch holding member.

3. The crown handling device as claimed in claim 2, wherein the matrix member is an elongated thin strap having two opposite ends passing through the two openings of the pinch holding member and secured to one side of one side of the pinch holding member.

4. The crown handling device as claimed in claim 3, wherein the two ends of the elongated thin strap are physically connected to form a loop.

5. The crown handling device as claimed in claim 1, wherein the matrix member is made of plastic.

6. The crown handling device as claimed in claim 1, wherein the matrix member includes a marking member.

7. The crown handling device as claimed in claim 6, wherein the marking member is an oiled paper.

8. The crown handling device as claimed in claim 6, wherein the marking member is a carbon paper.
